(19) United States
(12) Patent Application Publication
(10) Pub. No.: US 2011/0227798 A1
(43) Pub. Date: Sep. 22, 2011

(54) WIRELESS COMMUNICATION DEVICE

(75) Inventors: CHO-KANG HSU, Tu-Cheng (TW); YI-TING CHEN, Tu-Cheng (TW)

(73) Assignee: CHI MEI COMMUNICATION SYSTEMS, INC., Tu-Cheng City (TW)

(21) Appl. No.: 12/771,319

(22) Filed: Apr. 30, 2010

(30) Foreign Application Priority Data
Mar. 16, 2010 (TW) 99107551

(51) Int. Cl. H01Q 1/24

(52) U.S. Cl. 343/702

(57) ABSTRACT

A wireless communication device includes a housing and a circuit board. The circuit board includes a signal transmitting point and a grounding point. The housing connects to the signal transmitting point and the grounding point, and forms an antenna with the signal transmitting point and the grounding point.

### BACKGROUND

1. Technical Field

The disclosure generally relates to wireless communication devices, particularly to a miniaturized wireless communication device.

2. Description of Related Art

Antennas are usually assembled inside a portable wireless communication device to send and receive signals. The antennas often occupy a large space within the portable wireless communication device.

Therefore, there is room for improvement within the art.

### BRIEF DESCRIPTION OF THE DRAWINGS

Many aspects of the wireless communication device can be better understood with reference to the following drawings. The components in the drawings are not necessarily drawn to scale, the emphasis instead being placed upon clearly illustrating the principles of the wireless communication device.

FIG. 1 shows a schematic view of a wireless communication device, according to an exemplary embodiment.

FIG. 2 shows an exemplary test graph obtained from the wireless communication device of FIG. 1, disclosing return loss varying with frequency.

### DETAILED DESCRIPTION

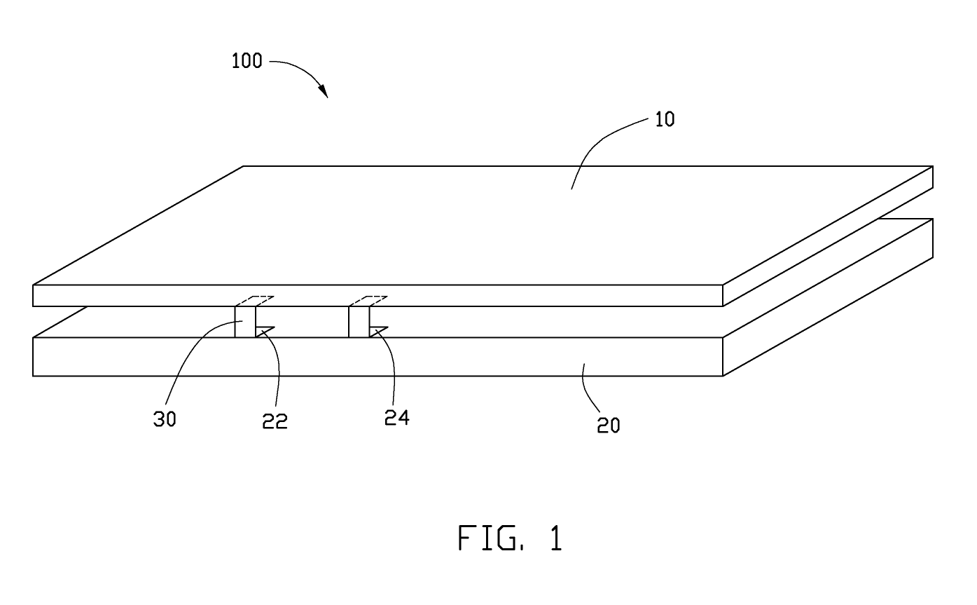

Referring to FIG. 1, a wireless communication device 100 such as a mobile phone or a personal digital assistant (PDA), according to an exemplary embodiment, includes a housing 10, a circuit board 20, and two connecting members 30. The circuit board 20 is connected to the housing 10 by the two connecting members 30.

The housing 10 is substantially a rectangular flat board made of conductive materials and may be a portion of a cover of a conventional wireless communication device. The circuit board 20 includes a signal transmitting point 22 and a grounding point 24. The housing 10 is parallel to and spaced from the circuit board 20. The housing 10 can be supported by other structural members (not shown) of the wireless communication device 100.

Each connecting member 30 is substantially an elastic, rectangular metal sheet. One connecting member 30 connects the housing 10 to the signal transmitting point 22 of the circuit board 20. Another connecting member 30 connects the housing 10 to the grounding point 24 of the circuit board 20. The housing 10 receives signals from and/or sends signals to the circuit board 20 through the signal transmitting point 22, and forms a loop antenna with the transmitting point 22 and the grounding point 24.

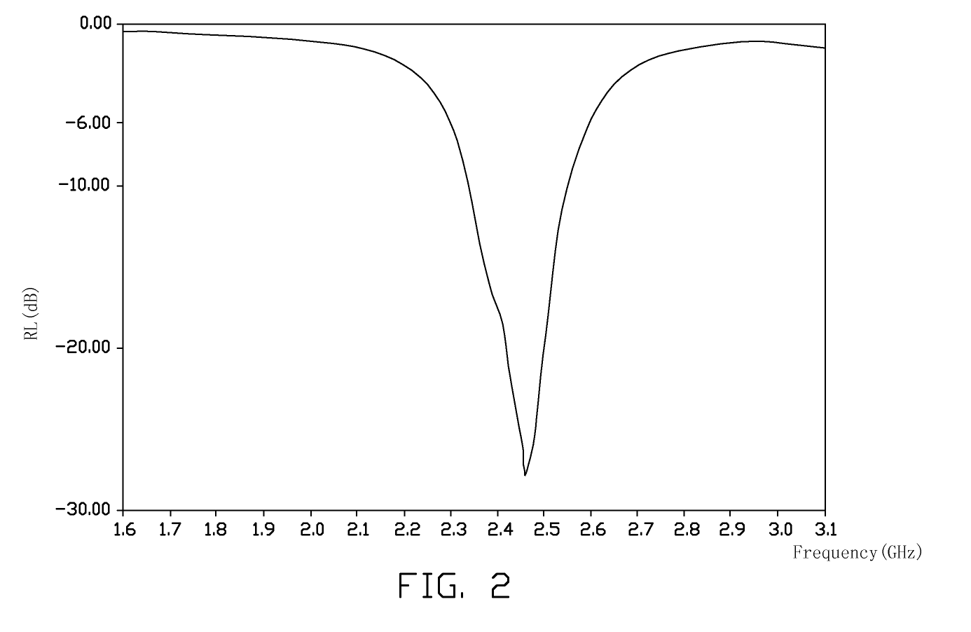

The dimensions of the housing 10 can be adjusted according to desired operating frequencies, such as a frequency band of 2.4˜2.5 GHz suitable for a Bluetooth communication system as shown in FIG. 2.

The wireless communication device 100 can be configured for different operating frequencies merely by adjusting dimensions of the housing 10, which acts as an antenna in cooperation with other parts, thus eliminating the need for a separately formed antenna and effectively further miniaturizes the wireless communication device 100.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A wireless communication device, comprising:
a housing; and
a circuit board including a signal transmitting point and a grounding point; wherein the housing connects to the signal transmitting point and the grounding point, and forms an antenna with the signal transmitting point and the grounding point.

2. The wireless communication device as claimed in claim 1, further including two connecting members; wherein one connecting member connects the housing to the signal transmitting point, another connecting member connects the housing to the grounding point.

3. The wireless communication device as claimed in claim 2, wherein each connecting member is an elastic sheet made of metal.

4. The wireless communication device as claimed in claim 1, wherein the antenna has a frequency band of 2.4˜2.5 GHz.

5. The wireless communication device as claimed in claim 1, wherein the antenna is a loop antenna.

6. The wireless communication device as claimed in claim 1, wherein the housing is portion of a cover of the wireless communication device.

7. The wireless communication device as claimed in claim 1, wherein the housing is made of conductive material.
